(19) United States
(12) Patent Application Publication
(10) Pub. No.: US 2007/0218241 A1
(43) Pub. Date: Sep. 20, 2007

(54) Method and device for adding moisture during cooking

(76) Inventor: Brian Eckerman, Woodstock, GA (US)

Correspondence Address: WITHERS & KEYS, LLC, P. O. BOX 71355, MARIETTA, GA, 30007-1355, US

(21) Appl. No.: 11/377,519

(22) Filed: Mar. 16, 2006

(51) Int. Cl. B32B 1/04

(52) U.S. Cl. 428/76

(57) ABSTRACT

Methods and devices increase the amount of moisture present during cooking to provide various benefits. A pad is placed in the close proximity to the food product. The pad in close proximity includes a fluid, either added to the pad prior to or after placement of the pad in proximity to the food. The food product with the pad in close proximity is then cooked, such as by a microwave or conventional oven, and the fluid of the pad produces steam during the cooking process that surrounds the food product to provide the various benefits.

### TECHNICAL FIELD

The present invention relates to cooking by increasing the moisture content present within the cooking device, such as within a microwave oven or a conventional oven. More particularly, the present invention relates to methods and devices for increasing the moisture content.

### BACKGROUND

Cooking methods have varied over the years. Conventional ovens used to be the primary manner of cooking foods. In recent years, the microwave method of cooking food has become a predominant method of cooking in the United States. Approximately 95% of Americans own a microwave and routinely microwave their meals. However, the use of the microwave oven has grown along with the acceptance of its shortcomings such as the uneven cooking, dehydration and the toughness of microwaved food. Incremental improvements to the microwave oven it self has ameliorated some of the shortcomings by adding food carousels to constantly rotate the food to even out hotspots.

Some solutions have come in the modification of FDA approved microwaveable food packages utilizing plastic film to seal food trays that need to be pierced before using or dielectric sleeves in which food is placed to concentrate heat energy to brown the food item. A bum danger may be present where the user attempts to peel back the plastic film while the contents are hot. Other solutions involve expensive compartmentalized microwave steamer trays which are messy and inconvenient to clean. Some solutions are home remedies such as the use of paper towels to prevent splattering or absorb grease. The paper towel may be wetted prior to being placed over the food. However, such home remedies are non-sanitary, messy due to leaks upon wetting the paper towel, are not efficient in terms of improving the cooking process, and are apt to fall apart. Furthermore, such home remedies have been expressly not recommended by one or more microwave manufacturers and could be hazardous.

Microwave cooking is an art and not a science. Despite the food producer's directions or recipes, the proper cooking of food in a microwave oven often requires some trial and error due to the multitude of models on the market reflecting different sizes, wattages, quality and other features. It is difficult to get the proper cooking result other than through trial and error. Over cooking, renders the food tough and overly dry. Under cooking obviously produces unsatisfactory if not inedible food.

Conventional ovens, while no longer the only source for cooking food, continues to be an important manner of cooking food as well. Conventional ovens may also suffer from some of the same drawbacks noted above for microwave ovens, such as dryness or toughness of the food product.

During or prior to cooking food by either the microwave or conventional method, the food product may produce byproducts including various fluids that are undesirable. To collect such byproducts during or prior to cooking, devices have been created that include a pad for absorbing the unwanted food byproducts. An example of such a device is disclosed in U.S. Pat. No. 5,552,169 to Kannankeril. While such devices may adequately absorb the unwanted food byproducts, such devices fail to assist in improving the cooking of the food product from which the byproducts are produced.

### SUMMARY

Embodiments of the present invention address these issues and others by providing a device consisting of a pad of absorbent material that may contain a liquid such as water. The pad with the entrained liquid may then be placed in proximity to the food to be cooked or alternatively the absorbent pad may be put in place before the liquid is added. While being cooked, the properties of liquid, such as water, results in the liquid flashing into steam resulting in the heat generated by the cooking device being distributed more evenly throughout food while at the same time adding moisture to prevent the food from drying out and becoming tough. The addition of moisture also may also reduce the effects from accidental over cooking. Furthermore, the use of an absorbent pad with entrained water has been shown to reduce the cooking time in some foods by as much as half of what it would normally be. Additionally, the pad may be placed over the food like a cover to prevent splattering and to retain additional steam.

In an exemplary embodiment of an apparatus for improved cooking includes an absorbent pad is encased by an upper and a lower layer of sealable sheet material extending beyond the periphery of the absorbent pad, the upper layer and lower layer secured together around their periphery to enclose the absorbent pad, wherein at least one of the upper or lower layers is perforated to provide liquid and gaseous permeability. The absorbent pad contains an amount of entrained liquid in a frozen state.

Another embodiment of an apparatus for improved cooking includes an absorbent pad is encased by an upper and a lower layer of sealable sheet material extending beyond the periphery of the absorbent pad, the upper layer and lower layer secured together around their periphery to enclose the absorbent pad, wherein at least one of the upper or lower layers is perforated to provide liquid and gaseous permeability. The absorbent pad contains an amount of entrained sterilized liquid.

Another embodiment of the invention is a method for cooking that includes placing the food to be cooked in proximity to an absorbent pad. The pad is encased between an upper and a lower layer of high temperature resistant sheet material extending beyond the periphery of the absorbent pad, the upper layer and lower layer secured together around their periphery to enclose the absorbent pad, wherein further at least one of the upper or lower layers is perforated to provide liquid and gaseous permeability. A substantially sterile liquid is added to the absorbent pad prior to cooking such that the sterile liquid is retained in the absorbent pad and will be released when the food and the absorbent pad are placed in the cooking device and the temperature of the food is raised.

Another embodiment is a system for improved cooking that includes a plurality of absorbent pads, each pad having an upper and a lower layer of a sealable high temperature heat sheet material, wherein the upper and lower layers are secured around their periphery and between each pad to enclose each pad. The pads, connected in series, are held in a container dimensioned to hold the plurality of absorbent pads. The container includes an access through a surface of the container which will allow passage of the plurality of pads. The embodiment includes a liquid retained in each absorbent pad of the plurality of absorbent pads held in the container. As such, a number of pads may be simply pulled from the container through the access and detached at the desired set of perforations.

Yet another embodiment includes a method for cooking food that includes first adding a liquid to an absorbent pad which is encased between an upper and a lower layer of sealable high temperature sheet material extending beyond the periphery of the absorbent pad, the upper layer and lower layer secured together around their periphery to enclose the absorbent pad, wherein further at least one of the upper or lower layers is perforated to provide liquid and gaseous permeability. The liquid becomes entrained in the pad so that the pad may then be placed in proximity to the food to be cooked whereby the absorbent pad and the food to be cooked are simultaneously placed into a cooking device and the temperature is raised for cooking.

### DESCRIPTION OF THE DRAWINGS

FIG. 1a is an exploded view of a single pad embodiment.

FIG. 1b is a cross sectional view of a single pad embodiment.

FIGS. 2a and 2b are a plan view and a cross sectional view, respectively, of a dual pad embodiment.

FIGS. 3a and 3b are a plan and a cross sectional view, respectively, of an embodiment with a plurality of pads.

FIG. 4a is a cross sectional side view of an exemplary packaging of a plurality of absorbent pads with fluid.

FIG. 4b is a cross sectional top view of an exemplary packaging of a plurality of absorbent pads with fluid.

FIG. 5 is an illustration of an embodiment of the invention applied to food to be cooked.

FIG. 6a is a flow diagram of the method using absorbent pads during cooking

FIG. 6b is a alternative flow diagram of the method using absorbent pads during cooking.

### DETAILED DESCRIPTION

Embodiments of the present invention include devices and methods for adding moisture during cooking. Certain embodiments of cooking devices include various features such as an absorbent pad encased in high temperature resistant sheet material containing a fluid added during food preparation. Certain embodiments of the device include certain preservative and flavoring additives contained in the fluid added during food preparation. Certain embodiments of the device include freezing the liquid entrained in the absorbent pad prior to food preparation and then applying the absent pad during food preparation. Furthermore, certain embodiments of devices include multiple absorbent pads connected in series by the high temperature resistant sheet material

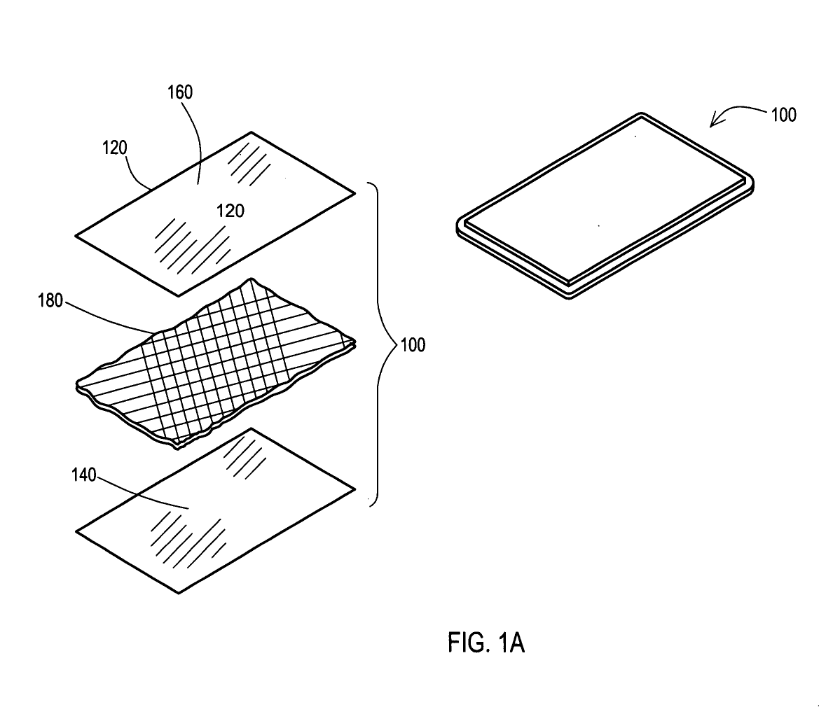

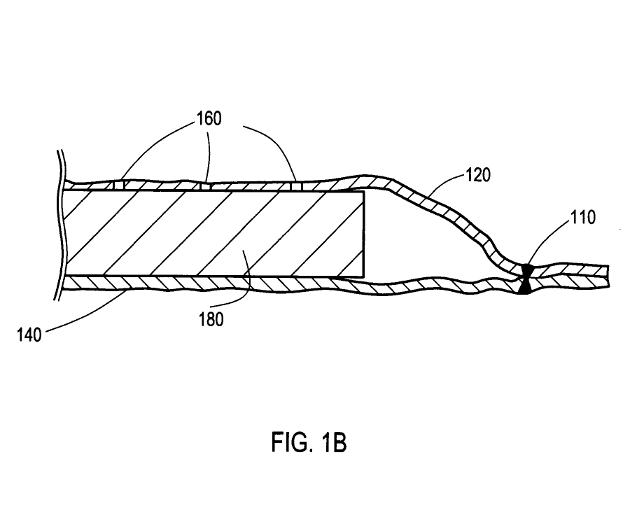

Referring more specifically to the drawings, there is shown in FIGS. 1a and 1b an exemplary form of the device embodying the features of the present invention. As illustrated in FIG. 1a, device 100 includes an upper layer of heat resistant sheet material 120 and a lower layer of heat resistant sheet material 140. The upper 120 and lower 140 sheet material may be of any composition that would be well known in the art commensurate with the expected cooking conditions. The upper 120 and lower 140 sheet material may be of different material composition. Examples of such materials include polyester, polyethylene terephalate, nylon, polypropylene, high density polyethylene, and the like.

The upper 120 and lower 140 sheet material encases an absorbent pad 180 which may be of any required dimensions and made of any heat resistant material commensurate with the expected cooking conditions as is well known in the art. Examples of such materials include wet strength tissue paper, release coated paper, and the like.

The upper 120 and lower 140 sheet material encases the absorbent pad 180 by being secured together around their periphery to enclose the absorbent pad 180. The upper 120 and lower 140 sheet material may be secured together by any means commensurate with the physical nature of the materials and the expected cooking conditions. Exemplary methods for sealing 110 the upper 120 and lower 140 sheet material may include adhesives, heat sealing or a zip lock.

FIG. 1b illustrates a cut away view of the exemplary cooking device 100 as assembled. As can be seen the upper 120 and lower 140 sheet material encases the absorbent pad 180 and is sealed at the periphery of the absorbent pad 180 at the sheet material seal 110. This area around the seal 110, where sheets 120 and 140 overlap, provides an area for the user to grasp after the cooking process has completed to avoid touching a hot pad 180.

Perforations 160 are included in at least one sheet of sealable high temperature sheet material in order to increase the permeability of the sheet to allow the user to add a substantially liquid to the pad 180 such that the liquid is entrained in the absorbent pad 180 prior to cooking. A liquid may be water or water with additives such as flavoring and preservatives. The perforations also allow greater gaseous permeability during cooking as the water turns to steam and seeks to escape from the cooking device under temperature. The lack of perforations in the second high temperature sheet of this particular embodiment prevents the water from exiting the cooking device prematurely before cooking. However, it will be appreciated that both sheets 120 and 140 may be perforated in certain embodiments in order to allow liquid to be entrained through both sheets 120 and 140 and/or to allow steam to escape through both sheets 120 and 140.

The perforations 160 of this embodiment as well as others discussed herein may be one-way valve type perforations as known in the art. These valves allow liquid to pass into the pad 180 but prevent the liquid from escaping until it becomes steam. Thus, where both sheets 120 and 140 are perforated, use of such one-way valves reduces the likelihood of fluid loss through either sheet.

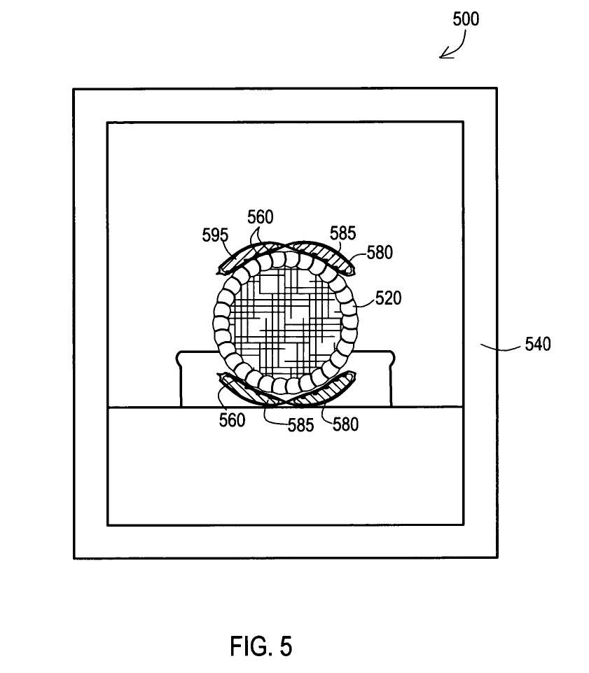

It should be noted that the liquid in the absorbent pad 180 may also be frozen after its addition. The cooking device 100 may be used in its frozen state by itself or may be used as part of the packaging of the food product or to help preserve and refrigerate the food product. The device 100 may be packaged individually or in sets. Furthermore, the device may be constructed into such a size and shape as to actually constitute a plate or a cover for a plate. The device may also be constructed so that it functionally benefits the food product, such as by being contoured to the shape of the food such as shown below in FIG. 5.

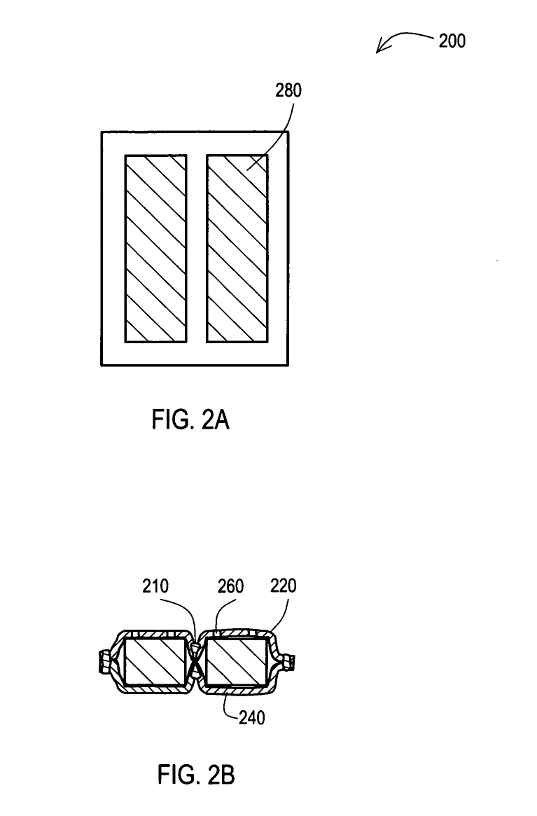

Further, there is shown in FIGS. 2a and 2b an embodiment of the cooking device 200 including two absorbent pads 280. As discussed above, the absorbent pads 280 are encased in an upper 220 and lower 240 high temperature resistant sheet of material sealed around the periphery of the absorbent pads. In this embodiment that entails that the upper 220 and lower 240 sheets of material be sealed between the absorbent pads 280 as well. The use of multiple or segmented pads provides flexibility during food preparation and during cooking so that the maximum surface area may be placed in contact with the food when so desired. Such flexibility may be particularly useful when the liquid in the absorbent pad 280 is in a frozen state.

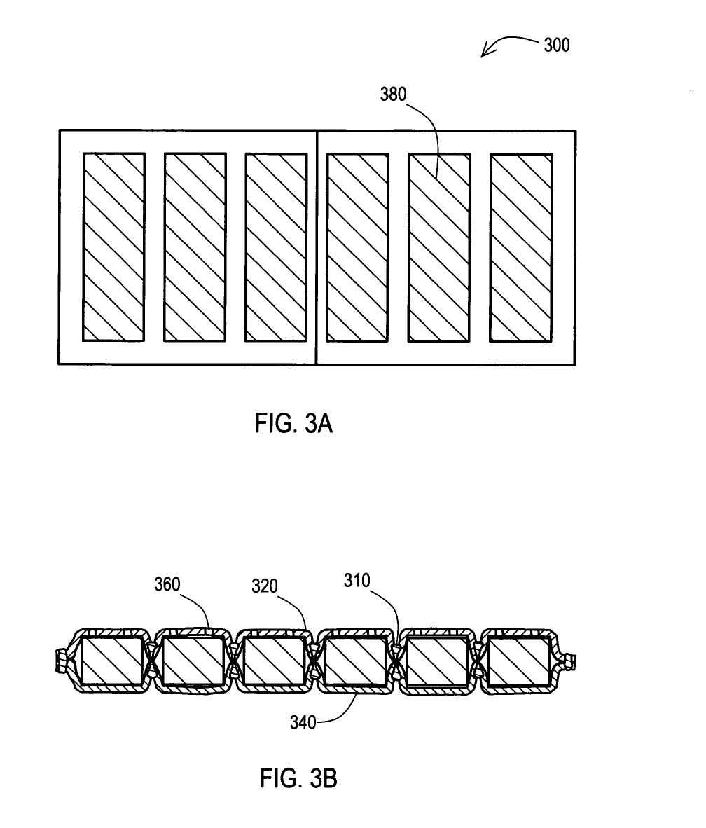

Further still, there is shown in FIGS. 3a and 3b an embodiment of the present invention whereby a plurality of absorbent pads 380 are connected in series by the upper 320 and lower 340 sheets of high temperature sheet material. Each absorbent pad 380 is sealed about its periphery which includes sealing the upper 320 and lower 340 sheets between each absorbent pad 380. At least one sheet of material 340 contains perforations 360 to increase the permeability of the sheet to the passage of the entrained substantially sterile liquid and the resulting steam created during cooking. The size of the absorbent pads 380 may be of any convenient size or shape. As a non-limiting example they may be rectangular as shown in FIG. 3 or they may be circular. The absorbent pads 380 may also be connected laterally as well and serially to form a checker board pattern as well. When connected in serial as illustrated in FIG. 3. Linear perforations 390 may be added between absorbent pads 380 to provide a convenient means for a user to separate a desired number of absorbent pads from the greater balance. Such linear perforations 390 may be created in a periodic fashion so that the perforation is created between a predetermined number of pads such that a fixed number of the absorbent pads may conveniently be removed as desired by the user.

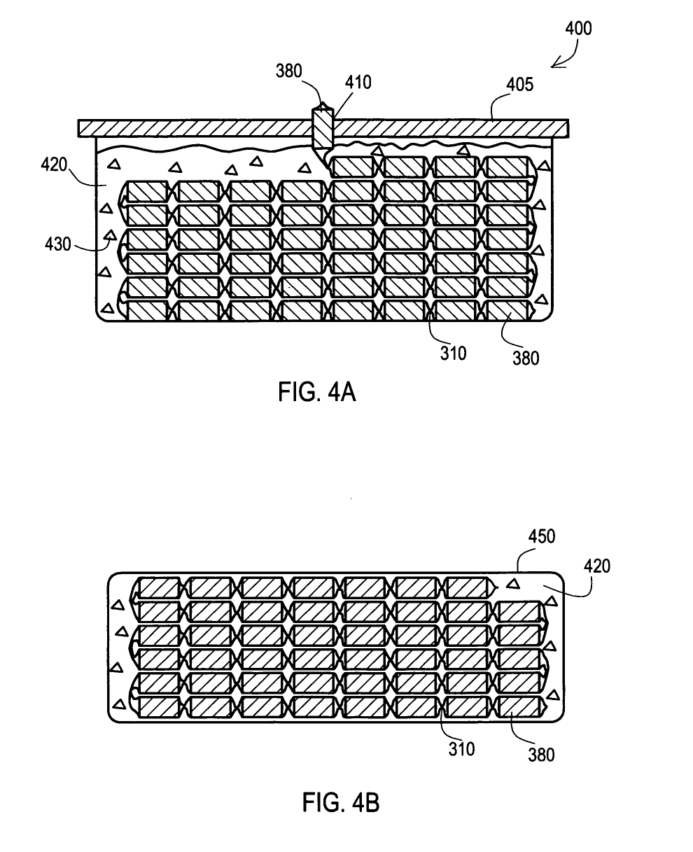

Further still, there is shown in FIG. 4a a plurality of absorbent pads 380 as described above and in FIG. 3 being stored in a sealable packaging container 400. It will be appreciated that each of the individual pads may be connected in series as shown in FIG. 4a or may alternatively be stored in the container 400 without the interconnection to adjacent pads. The packaging container may be of any dimension and made from any material that satisfies the requirements of the user and the dimensions of the absorbent pads 380. Examples include a plastic bag, a box with a removable top, and so forth. The sealable packaging container may be sealed in a variety of ways that are well known in the art of packaging such as a zip style of opening, a flap with adhesive, or a frictional fit top. The sealable packaging container 400 in the current exemplary embodiment is sealed by a lid 405. The lid 405 may contain an aperture 410 bounded by a rim of the material making up the lid 405. However, the aperture 410 may be located anywhere in the sealable packaging container 400 as suites the requirements of a user.

The sealable packaging container 400 may contain a liquid 420. The liquid 420 may be substantially sterile water or a solution including an additive 430 dissolved in substantially sterile water. The additive may be a flavoring or may be a preservative such as but not limited to Sodium Benzoate or Potassium Sorbate. The plurality of absorbent pads 380 are drawn serially form the sealable container 400 through aperture 410 and may be manually parted from the balance of the absorbent pads remaining in the container by tearing them at the linear perforations 390.

As suggested above, all of the embodiments may include the addition of a liquid to the absorbent pad. In most cases that liquid may be substantially sterile water. By substantially sterile water it is generally meant that the water will meet all governmental health requirements for ingestion by humans. Substantially sterile water would include all municipal tap water, commercially sold bottled water and other normal sources of potable water. It is recognized that no water source is perfectly sterile and will contain organic and inorganic material within some regulatory mandated limits.

An alternative to the configuration of FIG. 4a is shown in the top view of FIG. 4b, where the pads 380 are placed in a non-vertically-stacked formation, i.e., are stacked horizontally instead. In the vertically-stacked formation of FIG. 4a, the top pads 380 may retain less liquid 420 due to more absorption by the bottom pads and a drop in fluid level. In the non-vertically-stacked formation of FIG. 4b, each pad is equally submersed in the liquid 420. As noted for FIG. 4a, the pads may be included in the container connected in series as shown in FIG. 4b or may be stored without interconnection to adjacent pads.

In addition to the container with lid as shown in FIGS. 4a and 4b where multiple pads are stored in one container, an individual pad may be stored in its own separate container. Such a container may be a simple package such as that used to store a single wet wipe. The single pad per container configuration is particularly well suited to use at convenience store microwave ovens where the containers are placed alongside the microwave for use by patrons.

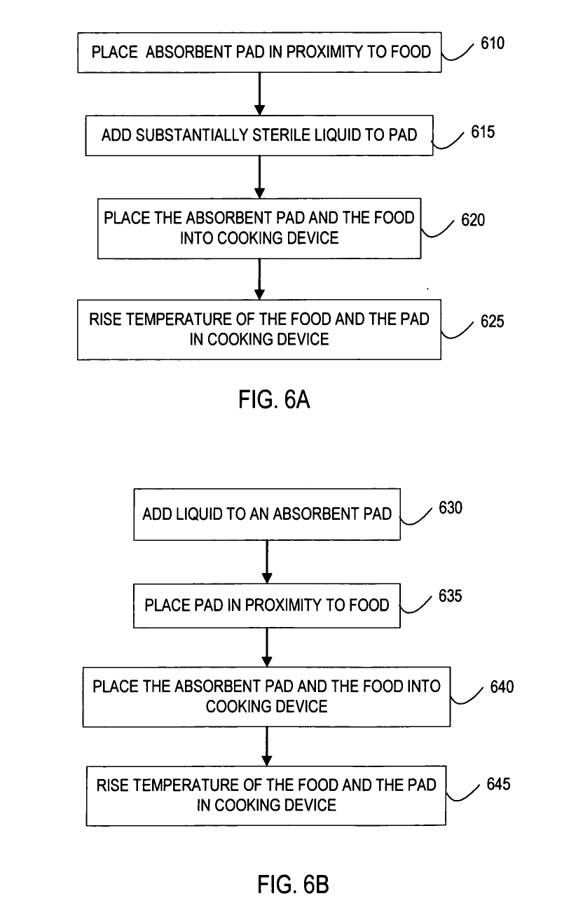

As illustrated in FIGS. 5 and 6a, the method for cooking with the absorbent pad 580 generally entails placing the absorbent pad 580 in proximity to the food to be cooked 520 shown in step 610. By in proximity it is meant at least inside the cooking device being used 540 such as a microwave or a conventional oven. However, in one embodiment the method entails placing the absorbent pad in contact with the food 520. The food 520 may be placed on top of the absorbent pad 580 with the perforations 560 facing upwards toward the food. An additional benefit of placing the absorbent pad 580 under the food 520 is that it may also function as a sponge to absorb any fluids that leave the food during cooking. Or, the absorbent pad 580 may be placed on top of the food 520 with the perforations 560 facing down. An advantage of placing the absorbent pad on top of the food is that the absorbent pad remains reasonably sterile and may be reused and that it acts as a lid to reduce splatter and retain more steam over the food. In another configuration, the food 520 may be wrapped by the absorbent pad 580.

Once the absorbent pad 580 is placed in proximity to the food 520, a substantially sterile fluid 585 is added to the absorbent pad in step 615. As mentioned above, the substantially sterile fluid may be potable water, other substantially sterile fluids not necessarily containing water, or it may be potable water containing an additive 595. The additive may be any desired substance. For example, such substances may be preservatives like Sodium Benzoate or it may be a particular flavoring such as a lemon or spice. The additive may be butter or butter substitute. The additive 595 does not have to be dissolved in the potable water thus forming a solution. It could, for example form a colloid in the potable water. It should be noted that substantially sterile fluid may also not contain potable water at all but may contain, as non-limiting examples, lemon, orange, apple juice, or au jus.

Once the absorbent pad 580, containing the substantially sterile liquid is in proximity to the food 520 in step 615, the absorbent pad and the food are placed inside the cooking device 540 in step 620 and the temperature of the cooking device 540 is raised to cook the food in step 625.

Another embodiment of the method for adding moisture with the absorbent pad is shown in FIG. 6b. FIG. 6b shows an exemplary method where in the substantially fluid 585 is added to the absorbent pad 580 as the first step 630 before placing the absorbent pad 580 in proximity to the food to be cooked 520. This method allows the fluid 585 to be added to the absorbent pad 580 far in advance of being placed in the cooking device 540 for cooking. The fluid 585 may be added in step 630 anytime prior to cooking. The fluid 585 may be added by a cook immediately before cooking in step 645 or the fluid 585 may be added far in advance during the absorbent pad's 580 manufacturing process and packaging. It may be desirable to package an individual absorbent pad or a plurality of pads 580 in an impermeable package after the fluid 585 is added, or as the fluid is added, and marketed as such. After the substantially sterile fluid is added to the absorbent pad in step 615, the absorbent pad 580 with the entrained fluid 585 is placed in proximity with the food to be cooked 520. As mentioned, supra, in proximity may encompass merely being placed inside a cooking device 540 with the food to be cooked 520. It may also encompass the absorbent pad wrapping the food 520 or being placed on top or underneath the food to be cooked 520. In step 640 and 645, the food 520 and the absorbent pad 580 are placed in a cooking device 540 and the temperature is raised to cook the food, respectively.

A comparison of affects of the pad involved utilizing a three-piece plastic steamer placed in a 1000 watt microwave oven with three to four ounces of frozen vegetables placed into the steamer. In a separate attempt, about three ounces of the same type of frozen vegetables were placed in the microwave with a pad according to one embodiment of the present invention placed atop these frozen vegetables. The pad included water in liquid form in both attempts. In both attempts, the vegetables were cooked for two minutes at the high power level and then removed. The vegetables within the steamer retained a cold temperature and were relatively uncooked. The vegetables under the pad were adequately cooked and achieved a warm temperature, thus demonstrating the benefits associated with utilizing a pad according to embodiments disclosed herein during the cooking process.

While the invention has been particularly shown and described with reference to various embodiments thereof, it will be understood by those skilled in the art that various other changes in the form and details may be made therein without departing from the spirit and scope of the invention.

What is claimed is:

1. An apparatus for improved cooking comprising:
an absorbent pad;
an upper and a lower layer of sheet material extending beyond the periphery of the absorbent pad, the upper layer and lower layer secured together around their periphery to enclose the absorbent pad, wherein at least one of the upper or lower layers is perforated to provide liquid and gaseous permeability;
a frozen liquid retained in the absorbent pad.

2. The apparatus of claim 1, wherein the sheet material is high temperature resistant and sealable.

3. The apparatus of claim 2, wherein the liquid is water.

4. The apparatus of claim 3, wherein the water contains an additive.

5. The apparatus of claim 4, wherein the additive is a flavor.

6. The apparatus of claim 1, further comprising a plurality of pads permanently connected together in series by the upper and lower layers of a high temperature resistant, sealable sheet material, wherein the upper and lower layers are secured around their periphery and between each pad to enclose each pad.

7. The apparatus of claim 6 wherein the high temperature resistant, sealable sheet material between two pads is perforated to allow convenient detachability using a predetermined periodicity to determine the location of the perforation.

8. The apparatus of claim 6 wherein the plurality of pads is detachably connected to another plurality of pads in series by the upper and lower layers of sheet material, wherein the upper and lower layers are secured around their periphery and between each pad to enclose each pad.

9. A method for cooking food comprising:
placing the food to be cooked in proximity to an absorbent pad, wherein the pad is encased between an upper and a lower layer of sheet material extending beyond the periphery of the absorbent pad, the upper layer and lower layer secured together around their periphery to enclose the absorbent pad, wherein further at least one of the upper or lower layers is perforated to provide liquid and gaseous permeability; and
adding a substantially sterile liquid to the absorbent pad, wherein the sterile liquid is retained in the absorbent pad.

10. The method of claim 9, further comprising:
placing the absorbent pad and the food to be cooked into a cooking device; and
raising the temperature of the food and the absorbent pad in the cooking device.

11. The method of claim 9 wherein the method for cooking includes freezing the liquid retained in the pad prior to placing the absorbent pad into proximity with the food.

12. The method of claim 9 wherein the perforated layer of sheet material is placed adjacent to the food to be cooked.

13. The method of claim 9 wherein the unperforated layer of sheet material is placed adjacent to the food to be cooked.

14. The method of claim 9 wherein the pad retaining the substantially sterile liquid is placed under the food to be cooked.

15. The method of claim 9 wherein the pad including the substantially sterile liquid and the food to be cooked are frozen together.

16. The method of claim 9 further comprising covering the food in the cooking container with the pad containing the substantially sterile liquid.

17. The method of claim 9 wherein adding a substantially sterile liquid to the absorbent pad occurs prior to placing the absorbent pad in proximity to the food, wherein further the substantially sterile liquid is retained in the absorbent pad.

18. A system for improved cooking comprising:
a plurality of absorbent pads, each pad having an upper and a lower layer of a sheet material, wherein the upper and lower layers are secured around their periphery and between each pad to enclose each pad;
a container dimensioned to hold the plurality of absorbent pads, wherein the container includes an access to allow passage of the plurality of pads; and
a liquid, wherein the liquid is retained in each absorbent pad of the plurality of absorbent pads held in the container.

19. The system of claim 18 wherein the liquid is entrained to the absorbent pads prior to being placed in the container.

20. The system of claim 18 wherein the liquid in the absorbent pads is frozen prior to being placed in the container.

21. The system of claim 20, wherein the upper and lower layers of the sheet material comprise high temperature resistant and sealable.

22. The system of claim 18, wherein further the pads are connected in series.

23. A method for cooking food comprising:
adding a liquid to an absorbent pad prior to placing the absorbent pad in proximity to the food, wherein the liquid is retained in the absorbent pad; and
placing the food to be cooked in proximity to the absorbent pad retaining the liquid, wherein the pad is encased between an upper and a lower layer of sheet material extending beyond the periphery of the absorbent pad, the upper layer and lower layer secured together around their periphery to enclose the absorbent pad, wherein further at least one of the upper or lower layers is perforated to provide liquid and gaseous permeability.

24. The method of claim 23, further comprising:
placing the absorbent pad and the food to be cooked into a cooking device; and
raising the temperature of the food and the absorbent pad in the cooking device.

25. The method of claim 23 wherein the liquid added to the pad is substantially sterile.

26. An apparatus for improved cooking comprising:
an absorbent pad;
an upper and a lower layer of sheet material extending beyond the periphery of the absorbent pad, the upper layer and lower layer secured together around their periphery to enclose the absorbent pad, wherein at least one of the upper or lower layers is perforated to provide liquid and gaseous permeability;
a substantially sterile liquid retained in the absorbent pad.
